(19) United States
(12) Patent Application Publication
(10) Pub. No.: US 2015/0095778 A1
(43) Pub. Date: Apr. 2, 2015

(54) MEDIA CONTENT MANAGEMENT

(71) Applicant: NOKIA CORPORATION, Espoo (FI)

(72) Inventors: Jussi LEPPANEN, Tampere (FI); Arto LEHTINIEMI, Lempaala (FI); Antti ERONEN, Tampere (FI)

(21) Appl. No.: 14/498,925

(22) Filed: Sep. 26, 2014

(30) Foreign Application Priority Data
Sep. 27, 2013 (GB) 1317212.7

(51) Int. Cl. G06F 3/0484; G06F 3/16; G06F 3/0481

(52) U.S. Cl. CPC G06F 3/04842; G06F 3/04817; G06F 3/165
USPC 715/716

(57) ABSTRACT

Apparatus, a method and a computer program are provided. The apparatus comprises: at least one processor; and memory storing computer program code configured, working with the at least one processor, to cause at least the following to be performed: responding to user input by selecting a media content item and a further media content item from multiple media content items in a playlist; causing at least one other media content item to be selected for inclusion in the playlist based on the selected media content item and the selected further media content item; and introducing the at least one other media content item into the playlist between the media content item and the further media content item.

### RELATED APPLICATION

This application claims priority to Great Britain Application No. 1317212.7 filed Sep. 27, 2014, which is incorporated herein by reference in its entirety.

### TECHNOLOGICAL FIELD

Embodiments of the present invention relate to media content management. In particular, they relate to introducing one or more media content items into a playlist.

### BACKGROUND

An electronic device may be configured to playback media content items, such as audio tracks, in a playlist. It is often necessary for a user to navigate away from a displayed playlist in order to enter new media content items into the playlist.

Also, in many circumstances, the user must choose individual media content items to add to the playlist; no assistance is provided by the electronic device.

### BRIEF SUMMARY

According to various, but not necessarily all, embodiments of the invention there is provided apparatus, comprising: at least one processor; and memory storing computer program code configured, working with the at least one processor, to cause at least the following to be performed: responding to user input by selecting a media content item and a further media content item from multiple media content items in a playlist; causing at least one other media content item to be selected for inclusion in the playlist based on the selected media content item and the selected further media content item; and introducing the at least one other media content item into the playlist between the media content item and the further media content item.

According to various, but not necessarily all, embodiments of the invention there is provided a method, comprising: responding to user input by selecting a media content item and a further media content item from multiple media content items in a playlist; causing at least one other media content item to be selected for inclusion in the playlist based on the selected media content item and the selected further media content item; and introducing the at least one other media content item into the playlist between the media content item and the further media content item.

According to various, but not necessarily all, embodiments of the invention there is provided apparatus comprising means for performing the method described above.

According to various, but not necessarily all, embodiments of the invention there is provided computer program code that, when performed by at least one processor, causes at least the following to be performed: responding to user input by selecting a media content item and a further media content item from multiple media content items in a playlist; causing at least one other media content item to be selected for inclusion in the playlist based on the selected media content item and the selected further media content item; and introducing the at least one other media content item into the playlist between the media content item and the further media content item.

The computer program code may be provided by a computer program stored on a non-transitory computer readable medium.

### BRIEF DESCRIPTION

For a better understanding of various examples that are useful for understanding the brief description, reference will now be made by way of example only to the accompanying drawings in which:

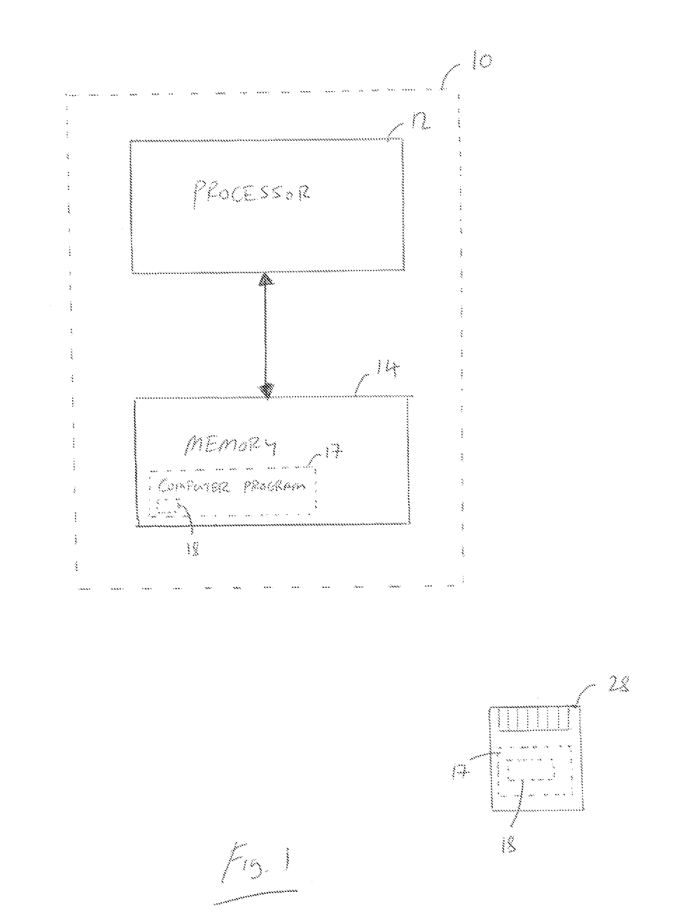

FIG. 1 illustrates a first apparatus in the form of a chipset;

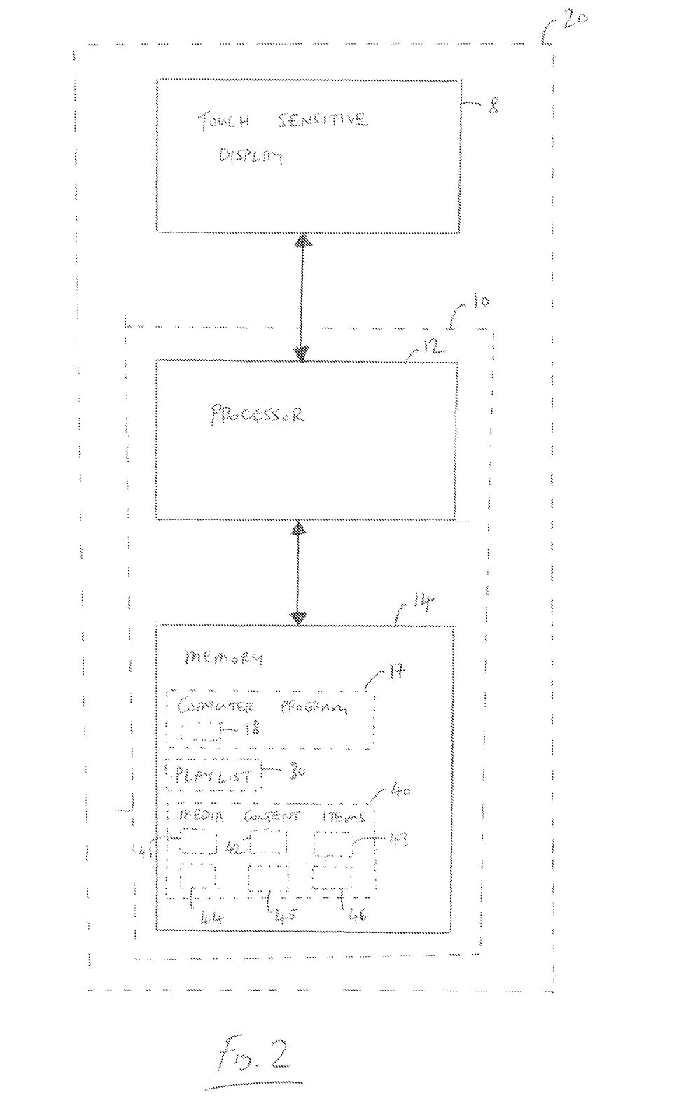

FIG. 2 illustrates a second apparatus in the form of an electronic device;

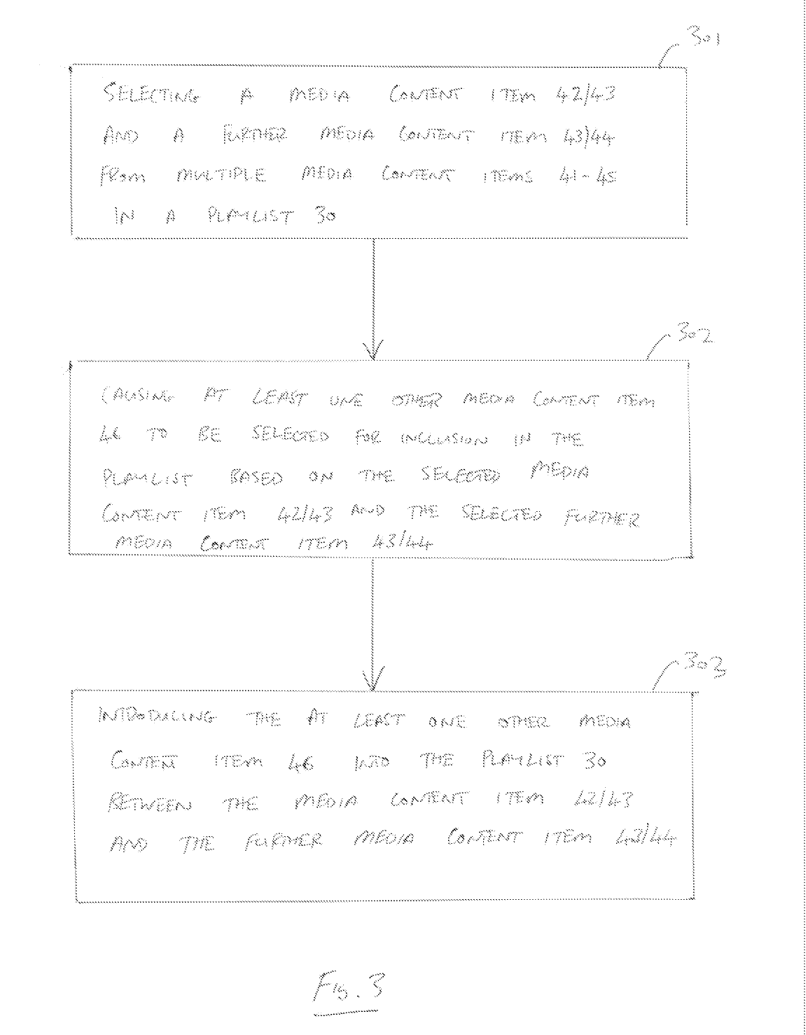

FIG. 3 is a flow chart of a method;

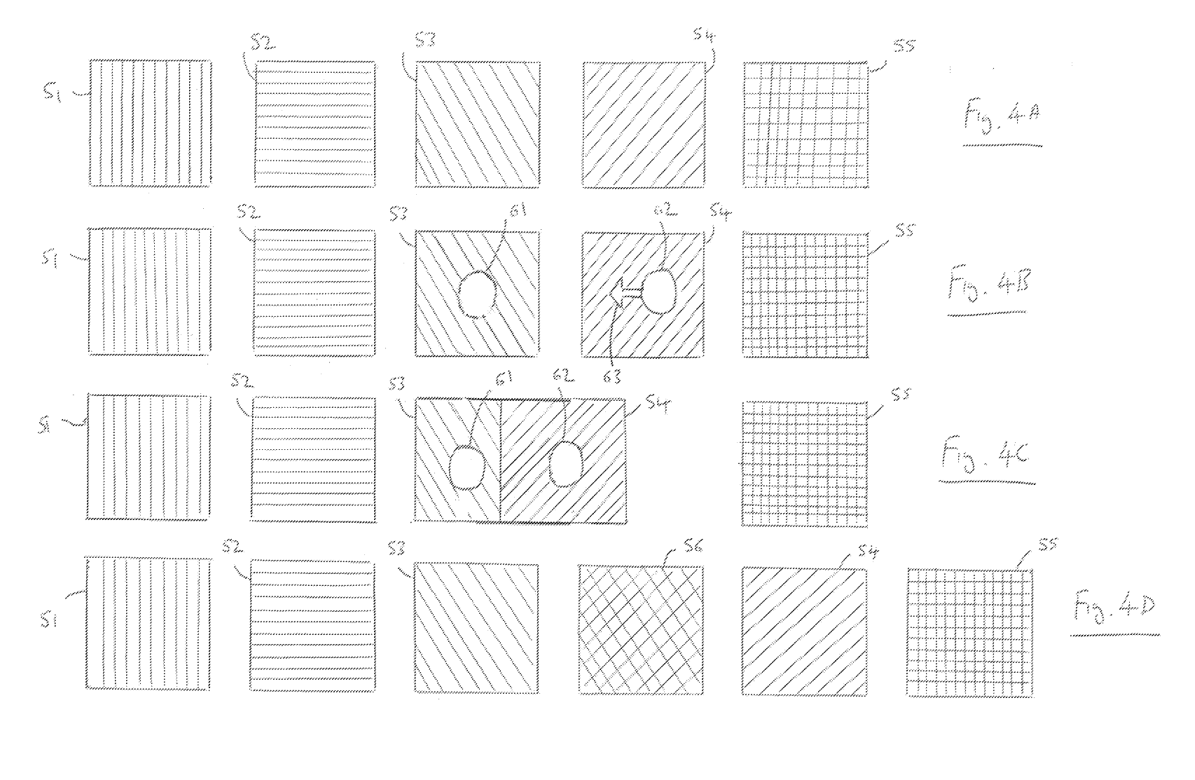

FIG. 4A illustrates a plurality of graphical representations of media content items in a playlist;

FIGS. 4B and 4C illustrate a closing pinch gesture being performed on two of the graphical representations illustrated in FIG. 4A;

FIG. 4D illustrates a plurality of graphical representations after an additional graphical representation has been added to the graphical representations illustrated in FIGS. 4A to 4C;

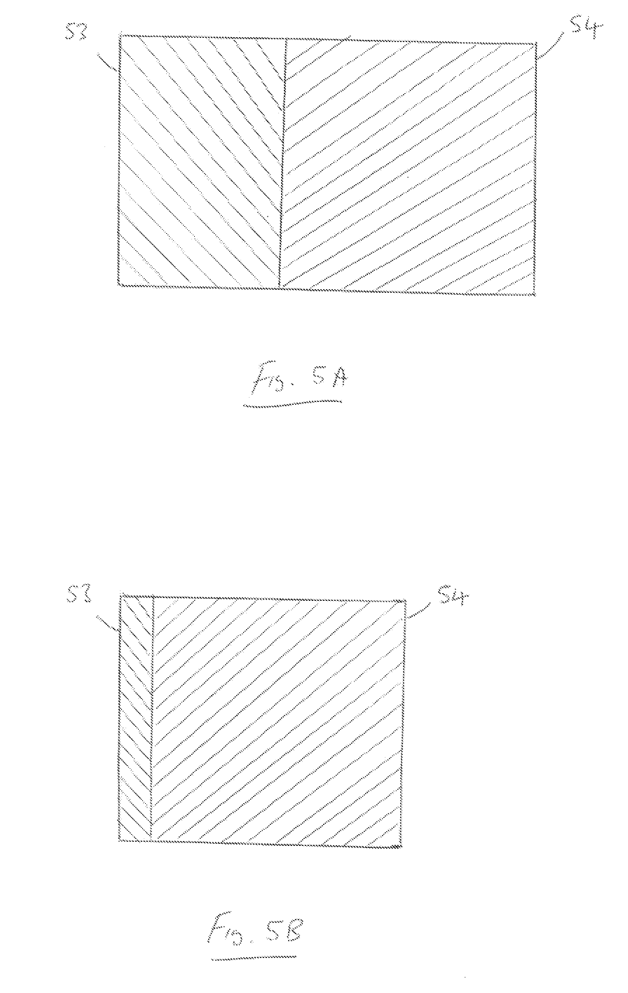

FIG. 5A illustrates a first example of two graphical representations coinciding as a closing pinch gesture is performed by a user;

FIG. 5B illustrates a second example of two graphical representations coinciding as a closing pinch gesture is performed by a user;

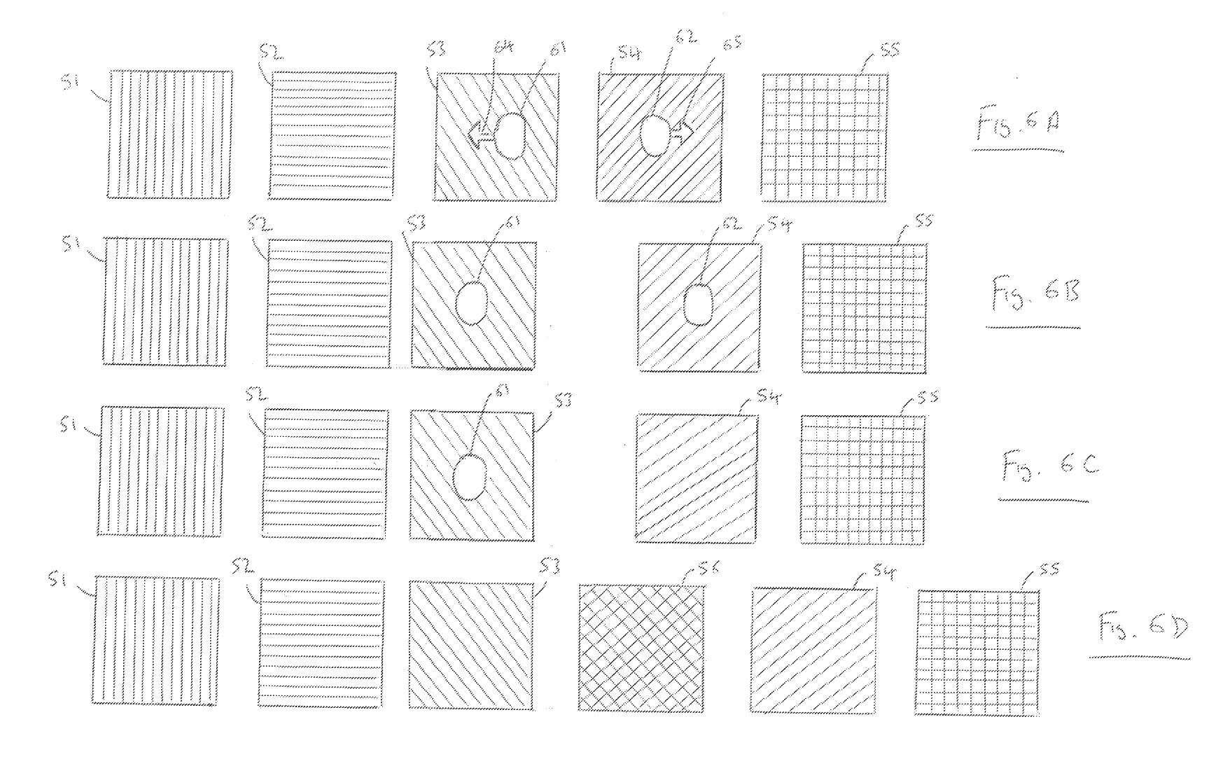

FIGS. 6A to 6C illustrate a plurality of graphical representations as a user performs an opening pinch gesture on two of the graphical representations;

FIG. 6D illustrates a plurality of graphical representations being displayed after an additional graphical representation has been added to the graphical representations illustrated in FIGS. 6A to 6C;

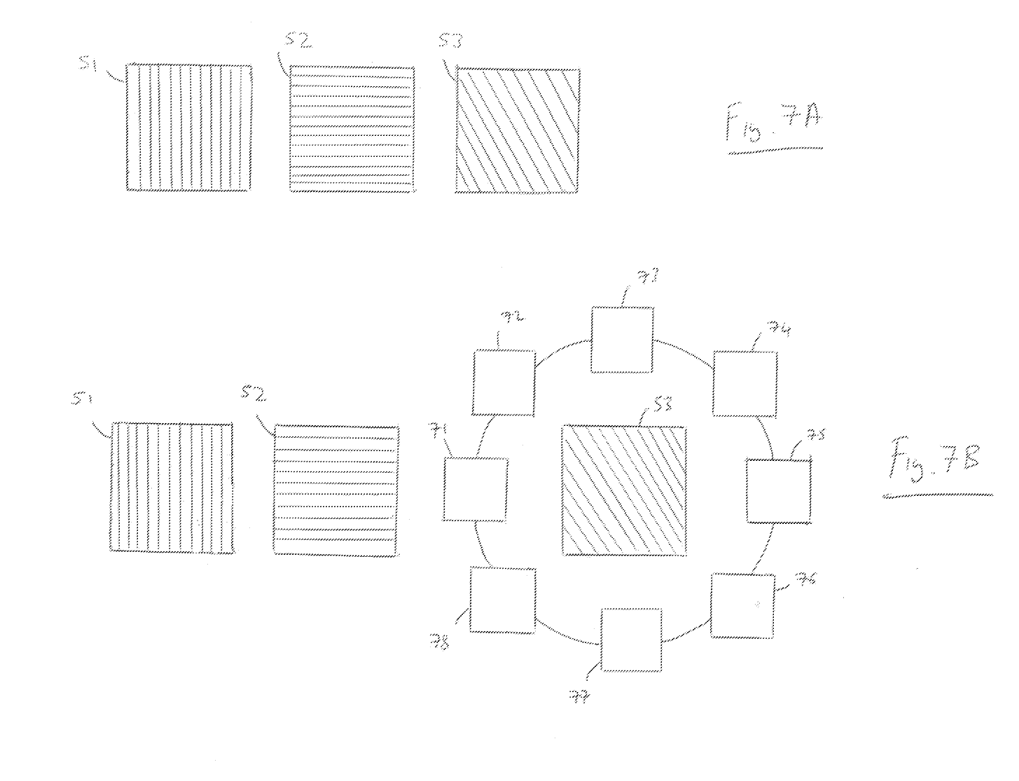

FIG. 7A illustrates a plurality of graphical representations;

FIG. 7B illustrates multiple additional graphical representations being displayed in a circular array after a user has performed an opening pinch gesture on two of the graphical representations illustrated in FIG. 7A;

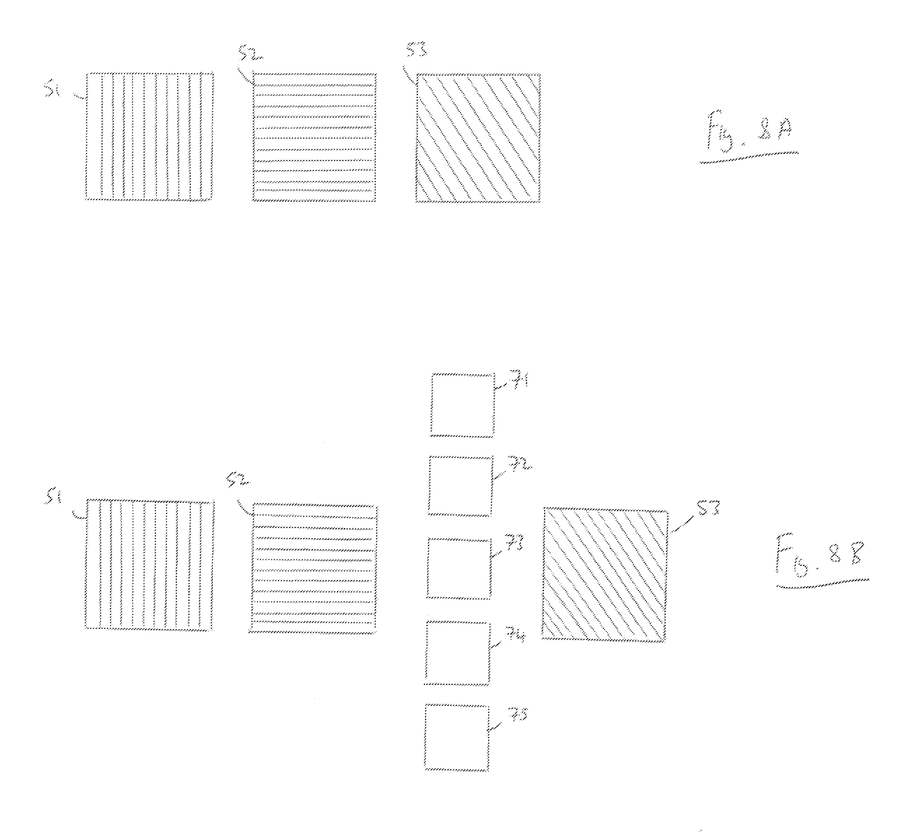

FIG. 8A illustrates a plurality of graphical representations; and

FIG. 8B illustrates multiple additional graphical representations being displayed in a linear array after a user has performed an opening pinch gesture on two of the graphical representations illustrated in FIG. 8A.

### DETAILED DESCRIPTION

Embodiments of the present invention relate to media content management and, in particular, to the introduction of media content items (such as audio tracks) into a playlist.

In this regard, the figures illustrate apparatus 10/20, comprising: at least one processor 12; and memory 14 storing computer program code 18 configured, working with the at least one processor 12, to cause at least the following to be performed: responding to user input by selecting a media content item 42/43 and a further media content item 43/44 from multiple media content items 41-45 in a playlist 30; causing at least one other media content item 46 to be selected for inclusion in the playlist 30 based on the selected media content item 42/43 and the selected further media content item 43/44; and introducing the at least one other media content item 46 into the playlist between the media content item 42/43 and the further media content item 43/44.

FIG. 1 illustrates an apparatus 10 that may be a chip or a chipset. The apparatus 10 may form part of an electronic device such as that illustrated in FIG. 1.

The apparatus 10 comprises at least one processor 12 and at least one memory 14. A single processor 12 and a single memory 14 are shown in FIG. 1 for illustrative purposes.

The processor 12 is configured to read from and write to the memory 14. The processor 12 may comprise an output interface via which data and/or commands are output by the processor 12 and an input interface via which data and/or commands are input to the processor 12.

The memory 14 stores a computer program 17 comprising computer program instructions/code 18 that control the operation of the apparatus 10 when loaded into the processor 12. The computer program code 18 provides the logic and routines that enables the apparatus 10 to perform the method illustrated in FIG. 3. The processor 12, by reading the memory 14, is able to load and execute the computer program code 18.

Although the memory 14 is illustrated as a single component it may be implemented as one or more separate components some or all of which may be integrated/removable and/or may provide permanent/semi-permanent/dynamic/cached storage.

The computer program code 18 may arrive at the apparatus 10 via any suitable delivery mechanism 28. The delivery mechanism 28 may be, for example, a non-transitory computer-readable storage medium such as a compact disc read-only memory (CD-ROM) or digital versatile disc (DVD). The delivery mechanism 28 may be a signal configured to reliably transfer the computer program code 18. The apparatus 10 may cause the propagation or transmission of the computer program code 18 as a computer data signal.

FIG. 2 illustrates an apparatus 20 in the form of an electronic device. The electronic device 20 may, for example, be a hand portable electronic device such as a mobile telephone, a tablet computer, a games console or a personal music player.

The example of the electronic device 20 illustrated in FIG. 2 includes a touch sensitive display 8 and the apparatus 10 illustrated in FIG. 1. The elements 8, 12 and 14 are operationally coupled and any number or combination of intervening elements can exist between them (including no intervening elements).

The touch sensitive display 8 is configured to display information under the control of the processor 12 and to receive touch inputs from a user. It may be any type of display. It may, for example, be a liquid crystal display (LCD), an organic light emitting diode (OLED) display or a quantum dot display. The touch sensitive display 8 may also include any type of touch sensing technology. For example, it might function using capacitive, resistive, infrared, dispersive signal and/or acoustic pulse technology. Touch inputs are received from a user input object such as a stylus or a user digit.

The memory 14 is illustrated in FIG. 2 as storing media content items 40 including first, second, third, fourth, fifth and sixth media content items 41-46. Each media content item is a separate, discrete, item. Each media content item could, for example, be an image (such as a photograph), video content (such as a movie or a television show) or an individual audio track.

Although the media content items 40 are illustrated in FIG. 2 as being stored in a local memory 14 in this example, in some embodiments of the invention, some or all of the media content items 40 might instead be stored remotely in a server. For example, the apparatus 20 may stream some or all of the media content items 40 from the server in order to play them.

FIG. 2 also shows the memory 14 storing a playlist 30. The playlist 30 defines an order of playback for media content items 40 stored in the memory 14 and/or stored in a remote server. For example, the playlist 30 could define an order of playback for audio tracks. Alternatively, if the media content items in the playlist 30 are images, the playlist 30 defines an order of playback for those images (for example, as a slideshow of images).

A first example of a method according to embodiments of the invention will now be described in relation to FIGS. 3 to 5B.

FIG. 4A illustrates a plurality of graphical representations 51-55 being displayed by the display 8 under the control of the processor 12. First, second, third, fourth and fifth graphical representations 51, 52, 53, 54, 55 are displayed which represent first, second, third, fourth and fifth media content items 41, 42, 43, 44, 45 respectively.

In this example, each graphical representation 51-55 is an image in the form of artwork. The artwork pictorially identifies the media content item. The artwork might be that which would appear on the sleeve of a hard copy version of the media content item (such as a compact disc version).

The graphical representations 51-55 of the media content items 41-45 are arranged in an order of playback defined by the playlist 30. The first media content item 41 to be played back is that represented by the first graphical representation 51, followed by the media content item 42 represented by the second graphical representation 52, followed by the media content item 43 represented by the third graphical representation 53, and so on.

In this example, the user decides that he wishes to add a new media content item to the playlist 30. In order to add a new media content item to the playlist 30, at block 301 in FIG. 3, the processor 12 responds to user input by selecting a media content item 43 and a further media content item 44 from the media content items 41-45 in the playlist 30.

The input provided by the user in this example is a “closing pinch gesture”, which is illustrated in FIGS. 4B and 4C. Initially, in FIG. 4B the user places a first user input object, such as a first user digit, in contact with the touch sensitive display 8 at the third graphical representation 53 (representing the third media content item 43) and a second user input object, such as a second user digit, in contact with the touch sensitive display 8 at the fourth graphical representation 54 (representing the fourth media content item 44). The first user digit might be a thumb and the second user digit might be a forefinger. The position of the first user digit is illustrated by the marker labelled with the reference numeral 61 and the position of the second user digit is illustrated by the marker labelled with the reference numeral 62 in FIG. 4B.

The user performs a closing pinch gesture by reducing the distance between the first and second user digits 61, 62. This is done by moving one or both of the user digits 61, 62 across the surface of the display 8, while the digits 61, 62 remain in contact with the display 8.

The processor 12 is configured to respond to movement of the first user digit 61 by controlling the third graphical representation 53 to move across the display 8 with the first user digit 61, such that it appears to be being dragged by the first user digit 61. Similarly, the processor 12 is configured to respond to movement of the second user digit 62 by controlling the fourth graphical representation 54 to move across the display 8 with the second user digit 62, such that it appears to be being dragged by the second user digit 62.

In this particular example, the user keeps the first digit 61 stationary and moves the second digit 62 towards the first digit 61. The third graphical representation 53 therefore remains stationary and the fourth graphical representation 54 moves towards the third graphical representation 53 in the direction identified by the arrow 63 in FIG. 4B.

Movement of the fourth graphical representation 54 causes the third and fourth graphical representations 53, 54 to coincide, as illustrated in FIG. 4C. In the illustrated example, the fourth graphical representation 54 coincides with the third graphical representation 53 by overlapping it.

The processor 12 responds to the removal of one or both digits from the display 8 while the third and fourth graphical representations 53, 54 are coincident by selecting the third and fourth media content items 43, 44 for use in selecting at least one other media content item to add to the playlist 30 between the third and fourth media content items 43, 44. In some alternative implementations, merely the removing one digit from the display 8 may cause the processor 12 to make the selection.

At block 302 in FIG. 3, the processor 12 causes one or more other media content items to be selected for inclusion in the playlist 30 based on the selected third and fourth media content items 43, 44. In some embodiments, the one or more other media content items are selected by the processor 12. In other embodiments, the selected third and fourth media content items 43, 44 are identified to a remote server, and the remote server makes the selection. The selection of one or more media content items to be added to the playlist 30 can be made in a variety of different ways. The selection might be made by identifying one or more media content items that have one or content characteristics that are the same or similar to those in the selected third and fourth media content items. For example, if the media content items are audio tracks (such as music tracks) the “content characteristics” might be musical/aural characteristics. In this regard, the musical/aural similarity of audio tracks may be determined by analyzing metadata associated with audio tracks rather than the audio itself. That is, in some implementations, the server/processor 12 may analyze metadata associated with the third and fourth media content items 43, 44 and select one or more media content items to add to the playlist 30 on the basis of the analysis.

For example, the server/processor 12 may use the metadata to determine the genre of the third media content item 53 and the genre of the fourth media content item 54. The server/processor 12 may then use those genres to select media content item(s) to add to the playlist 30. The genre of the media content item(s) that is/are selected for addition to playlist 30 may therefore depend on the genres of the selected third and fourth media content items 43, 44. For instance, the genre of media content items that are selected for addition to the playlist may be the same or similar to the genre(s) of the third and fourth media content items 43, 44.

Alternatively or additionally, musical/aural characteristics other than the genre of the third and fourth media content items 53, 54 might be used, such as tempo.

Alternatively or additionally, in some embodiments of the invention, the server/processor 12 may select one or more media content items for inclusion in the playlist 30 that: i) are owned by a number of other users that also own the third and fourth media content items 43, 44, and/or ii) have been consumed (for example, listened to) by other users that have also consumed the third and fourth media content items 43, 44.

At block 303 in FIG. 3, the processor 12 introduces the one or more additional media content items into the playlist 30 between the third and fourth media content items 43, 44. In the example illustrated in FIG. 4D, the processor 12 introduces a sixth media content item 46 between the third and fourth media content items 43, 44 such that the sixth media content item will be played back after the third media content item 43 and before the fourth media content item 44. When the sixth media content item 46 is added to the playlist 30, the processor 12 also adds a sixth graphical representation 56, representing the sixth media content item 46, into the depiction of the playlist 30 displayed on the display 8. This is illustrated in FIG. 4D.

In some implementations of the invention, a process for selecting the media content item(s) for inclusion in the playlist 30 depends upon the extent to which the third and fourth graphical representations 53, 54 coincide when user input is provided to select the third and fourth media content items 43, 44.

FIG. 5A illustrates an example in which the fourth graphical representation 54 overlaps the third graphical representation 53, but the area of overlap/coincidence is small. Two-thirds of the third graphical representation 53 remains exposed.

FIG. 5B illustrates an example in which the fourth graphical representation 54 overlaps the third graphical representation 53, and the area of overlap/coincidence is large. Only one-tenth of the third graphical representation 53 remains exposed.

The greater the exposure that a graphical representation has when selected, the more influence its associated media content item has in the selection of additional media content items for inclusion in the playlist 30.

For example, when one or more media content items are selected for inclusion into the playlist 30, the fourth media content item 44 will have more influence over the selection in the example illustrated in FIG. 5B than in the example illustrated in FIG. 5A. In circumstances where the user wishes the third media content item 43 to be more influential than the fourth media content 44 item, he would provide user input that causes the third graphical representation 53 to overlap the fourth graphical representation 54 by moving the third graphical representation 53 towards the fourth graphical representation 54.

FIGS. 6A to 6D illustrate an alternative example of the method from that illustrated in FIGS. 4A to 5B. The example illustrated in FIGS. 6A to 6D differs from that illustrated in FIGS. 4A to 4D in that an “opening pinch gesture” is performed on the third and fourth graphical representations 53, 54, rather than a closing pinch gesture, to cause the processor 12 to select the third and fourth media content items 43, 44.

Initially, in FIG. 6A the user places a first user input object, such as a first user digit 61, in contact with the touch sensitive display 8 at the third graphical representation 53 (representing the third media content item 43) and a second user input object, such as a second user digit 62, in contact with the touch sensitive display 8 at the fourth graphical representation 54 (representing the fourth media content item 44). The first user digit 61 might be a thumb and the second user digit 62 might be a forefinger.

The user performs an opening pinch gesture by increasing the distance between the first and second user digits 61, 62. This is done by moving one or both of the user digits 61, 62 across the surface of the display 8, while the digits 61, 62 remain in contact with the display 8.

The processor 12 is configured to respond to movement of the first user digit 61 by controlling the third graphical representation 53 to move across the display 8 with the first user digit 61, such that it appears to be being dragged by the first user digit 61. The movement of the third graphical representation 54 is indicated by the arrow labelled with the reference numeral 64 in FIG. 6A. Similarly, the processor 12 is configured to respond to movement of the second user digit 62 by controlling the fourth graphical representation 54 to move across the display 8 with the second user digit 62, such that it appears to be being dragged by the second user digit 62. The movement of the fourth graphical representation 54 is indicated by the arrow labelled with the reference numeral 65 in FIG. 6A.

FIG. 6B illustrates an instance in time in which the user digits 61, 62 are in still in contact with the display 8 after the opening pinch gesture has been performed by the user. In this example, the user lifts the second digit 62 from the surface of the display 8 before he lifts the first digit 61 from the display 8. FIG. 6C illustrates an instance in time in which the user has lifted the second digit 62 from the display 8, but not the first digit 61.

In this example, once the user has removed the first digit 61 from the display 8, the processor 12 responds by selecting the third and fourth media content items 43, 44 for use in selecting at least one other media content item to add to the playlist 30. The processor 12 then causes one or more other media content items to be selected for inclusion in the playlist 30 based on the selected third and fourth media content items 43, 44 in the manner described above in relation to block 302 in FIG. 3.

This example differs from that illustrated in FIGS. 4A to 5B in that the process for selecting the media content item(s) for inclusion in the playlist 30 does not depend upon the extent to which the third and fourth graphical representations 53, 54 coincide. Instead, the process for selecting the media content item(s) for inclusion in the playlist depends upon whether, after performance of the opening pinch gesture by the user, user input is maintained at either the third graphical representation 53 or the fourth graphical representation 54.

In this example, user input is maintained at the third graphical representation 53 and not at the fourth graphical representation 54, as illustrated in FIG. 6C. After determining this, the processor 12 controls the process for selecting the media content item(s) for inclusion in the playlist 30 such that the third media content item 43 (corresponding with the third graphical representation 53) is more influential in the selection of the media content item(s) than the fourth graphical representation 54.

FIG. 6D illustrates the display 8 after a sixth media content item 46 has been selected and introduced between the third and fourth media content items 43, 44. A sixth graphical representation 56 is displayed, between the third and fourth graphical representations 53, 54, which represents the sixth media content item 46.

FIGS. 7A-7B and FIGS. 8A-8B illustrate some further examples of how user input comprising an opening pinch gesture can be used to add media content items to a playlist 30. In the FIG. 7A example, performing an opening pinch gesture on the second and third graphical representations 52, 53 causes the processor 12 to control the display 8 to display multiple additional graphical representations 71-78 after the distance between the second and third graphical representations 52, 53 has been increased. The media content items that are represented by the additional graphical representations 71-78 depend upon the media content items 42, 43 that are selected when the opening pinch gesture is performed.

The multiple additional graphical representations 71-78 may appear before or after the user has lifted his digits from the display 8 following performance of the opening pinch gesture. In the example illustrated in FIG. 7B, the additional graphical representations 71-78 are arranged in a circular array. A stationary touch input at one of additional graphical representations 71-78 may cause the processor 12 to respond by introducing the corresponding media content item to the playlist 30. A swipe input at the circular array of additional graphical representations 71-78 may cause the processor 12 to respond by rotating the additional graphical representations 71-78 in a circular manner.

In some implementations, the user may maintain a digit at the third graphical item 53 after performing the opening pinch gesture and use the digit that was positioned at the second graphical representation 52 to provide a stationary touch input to select one of the additional graphical representations 71-78 or to provide a swipe input to rotate the additional graphical representations 71-78.

The example illustrated in FIGS. 8A and 8B differs from that illustrated in FIGS. 7A to 7B in that the multiple additional graphical representations 71-75 are displayed in a linear array rather than a circular array. A swipe input at the linear array may cause the processor 12 to respond by scrolling through the additional graphical representation 71-75, causing graphical representations to appear that are not shown in FIG. 8B.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed- function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

The blocks illustrated in the FIG. 3 may represent steps in a method and/or sections of code in the computer program code 18. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

For instance, examples have been described above in relation to FIGS. 4A to 5B, 6A to 6D, 7A to 7B and 8A to 8D where the user provides either a closing pinch gesture or an opening pinch gesture to cause the processor 12 to select two media content items 42/43, 43/44 which are subsequently used to identify one or more other media content items for inclusion in the playlist 30. However, it is not necessary for such pinch gestures to be used. Instead of using a pinch gesture, in some implementations, a user may cause the processor 12 to move a graphical representation 52/53/54 by merely providing touch input at that graphical representation using a digit and then moving the digit across the display 8 while that digit remains in contact with the display 8. For instance, in the FIG. 6A to 6D, 7A to 7B and 8A to 8D examples described above, when a graphical representation is moved away from an adjacent graphical representation by the user using a single digit, the media content items corresponding with both of those adjacent graphical representations may be selected by the processor 12.

A further alternative to the pinch gesture might be for the user to provide long touch inputs (that is, touch inputs for longer than a threshold period of time) simultaneously at two graphical representations in order to select those graphical representations and cause one or more new media content items to be added to the playlist 30.

Although examples have been described above in the context of audio tracks and associated album artwork, as mentioned above, the media content items could instead be a different type of media item such as images. For instance, a playlist might define an order of playback for the holiday photos of a user. In one illustrative example, a user might select a first image, depicting his daughter, with his first digit 61 and a second image, depicting a beach, with his second digit 62 in order to cause one or more new images to be added to the playlist 30. If, for instance, in making the selection the first image is moved such that it overlaps the second image, the first image may have more influence in the selection of the new image(s) which are added to the playlist.

In the case of images, the new, similar images may be determined, for example, based on content-analysis based methods, which are based either on metadata tags assigned by one or more users or by automatic algorithms recognizing, for example, objects in the image.

In some examples, each of the graphical representations might represent a plurality of media content items instead of a single media content item. For example, each graphical representation displayed on the display could represent an album which comprises a plurality of audio tracks, or could represent a plurality of audio tracks by a particular artist. In the event that a user selects displayed artist images, one or more new graphical items, each representing audio tracks by a new (similar) artist may be added to the playlist. Artist similarity may be measured in various ways, for example, using the similarity of their listener populations, their genres, or other tags provided by users.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

What is claimed is:

1. An apparatus, comprising:
at least one processor; and
at least one memory including computer program code, the memory and the computer program code configured to, working with the at least one processor, cause the apparatus to perform at least the following:
responding to user input by selecting a media content item and a further media content item from multiple media content items in a playlist;
causation of at least one other media content item to be selected for inclusion in the playlist based on the selected media content item and the selected further media content item; and
introduction of the at least one other media content item into the playlist between the media content item and the further media content item.

2. The apparatus as claimed in claim 1, wherein selection of the at least one other media content item is made using one or more content characteristics of the media content item and the further media content item.

3. The apparatus as claimed in claim 1, wherein the media content item, the further media content item, and the at least one other media content item are audio tracks.

4. The apparatus as claimed in claim 1, wherein the memory includes computer program code configured to, working with the at least one processor, cause the apparatus to perform causation of a display to display a graphical representation that represents the media content item and a further graphical representation that represents the further media content item, wherein the introduction of the at least one other media content item into the playlist comprises introduction of at least one other graphical representation that represents the at least one other media content item between the graphical representation and the further graphical representation.

5. The apparatus as claimed in claim 4, wherein responding to the user input comprises causing the graphical representation to coincide with the further graphical representation.

6. The apparatus as claimed in claim 4, wherein the user input which causes the graphical representation and the further graphical representation to coincide comprises a closing pinch gesture.

7. The apparatus as claimed in claim 4, wherein responding to the user input comprises increasing a distance between the graphical representation and the further graphical representation.

8. The apparatus as claimed in claim 8, wherein the user input which causes a distance between the graphical representation and the further graphical representation to increase is an opening pinch gesture.

9. The apparatus as claimed in claim 8, wherein the memory includes computer program code configured to, working with the at least one processor, cause the apparatus to perform causation of multiple additional graphical representations that represent multiple additional media content items to be displayed after the distance between the graphical representation and the further graphical representation has been increased, wherein the multiple additional graphical representations include the at least one other graphical representation.

10. A method, comprising:
responding to user input by selecting a media content item and a further media content item from multiple media content items in a playlist;
causing at least one other media content item to be selected for inclusion in the playlist based on the selected media content item and the selected further media content item; and
introducing the at least one other media content item into the playlist between the media content item and the further media content item.

11. The method as claimed in claim 10, wherein selection of the at least one other media content item is made using one or more content characteristics of the media content item and the further media content item.

12. The method as claimed in claim 10, wherein the media content item, the further media content item, and the at least one other media content item are audio tracks.

13. The method as claimed in claim 10, further comprising causing a display to display a graphical representation that represents the media content item and a further graphical representation that represents the further media content item, wherein introducing the at least one other media content item into the playlist comprises introducing at least one other graphical representation that represents the at least one other media content item between the graphical representation and the further graphical representation.

14. The method as claimed in claim 13, wherein responding to the user input comprises causing the graphical representation to coincide with the further graphical representation.

15. The method as claimed in claim 14, wherein the user input which causes the graphical representation and the further graphical representation to coincide comprises a closing pinch gesture.

16. The method as claimed in claim 13, wherein responding to the user input comprises increasing a distance between the graphical representation and the further graphical representation.

17. The method as claimed in claim 16, wherein the user input which causes a distance between the graphical representation and the further graphical representation to increase is an opening pinch gesture.

18. The method as claimed in claim 16, further comprising: causing multiple additional graphical representations, representing multiple additional media content items, to be displayed after the distance between the graphical representation and the further graphical representation has been increased, wherein the multiple additional graphical representations include the at least one other graphical representation.

19. A non-transitory computer readable medium storing computer program code that, when performed by at least one processor, causes at least the following to be performed:
responding to user input by selecting a media content item and a further media content item from multiple media content items in a playlist;
causation of at least one other media content item to be selected for inclusion in the playlist based on the selected media content item and the selected further media content item; and
introduction of the at least one other media content item into the playlist between the media content item and the further media content item.

20. The computer readable medium as claimed in claim 19, wherein selection of the at least one other media content item is made using one or more content characteristics of the media content item and the further media content item.
